(19) United States
(12) Patent Application Publication
(10) Pub. No.: US 2015/0032516 A1
(43) Pub. Date: Jan. 29, 2015

(54) MANAGING ELECTRIC VEHICLE (EV) CHARGING STATION USAGE

(71) Applicant: International Business Machines Corporation, Armonk, NY (US)

(72) Inventors: Ajay Deshpande, White Plains, NY (US); Pavankumar Murali, Haverstraw, NY (US)

(73) Assignee: INTERNATIONAL BUSINESS MACHINES CORPORATION, Armonk, NY (US)

(21) Appl. No.: 14/210,408

(22) Filed: Mar. 13, 2014

Related U.S. Application Data
(60) Provisional application No. 61/857,913, filed on Jul. 24, 2013.

(51) Int. Cl. G06Q 50/06; G06Q 10/02; G06Q 50/30; G07B 15/02

(52) U.S. Cl. CPC G06Q 50/06; G07B 15/02; G06Q 10/02; G06Q 50/30
USPC 705/13

(57) ABSTRACT

A system, method and program product for managing charging station usage. After receiving a request for charging capacity in electric vehicle (EV) charging spaces, e.g., located in commercial parking lots, if it can be fulfilled the request is accepted. Each accepted request is matched with available EV charging spaces. A scheduling unit schedules charging for each request to a matched EV charging space when a charging price is predetermined. Otherwise, if a charging price is not previously determined, a pricing unit sets a permit price and schedules charging for the match.

### CROSS REFERENCE TO RELATED APPLICATION

The present application is continuation/utility application of provisional U.S. Patent Application No. 61/857,913 (Attorney Docket No. YOR920130605US1), “System And Method For EV Charging Station Management” to Ajay A. Deshpande et al., filed Jul. 24, 2013; and related to published U.S. Application patent Ser. No. 13/403,046 (Attorney Docket No. YOR920120041US1), “ELECTRIC VEHICLE (EV) CHARGING INFRASTRUCTURE WITH CHARGING STATIONS OPTIMALLY SITED” to Jing D. Dai et al., both assigned to the assignee of the present invention and incorporated herein by reference.

### BACKGROUND OF THE INVENTION

1. Field of the Invention

The present invention is related to transportation and more particularly to managing electric vehicle (EV) charging station usage to satisfy demand for charging stations located across a geographical area.

2. Background Description

The typical electric vehicle (EV) or plug-in hybrid EV (PHEV) operates on a large on-board energy storage cell or rechargeable battery. EV battery capacity limits the distances EVs can travel on a single charge. Historically, high capacity batteries and sufficiently large, high efficiency electric motors for long range travel have been unavailable. Limited battery capacity has limited EV travel to relatively short distances. Most EV drivers have sufficient charge capacity at home for short-range, local travel. Frequently however, drivers want to take trips long enough that vehicles must be recharged away from home, e.g., at a workplace parking lot, in elevated parking at a shopping center or airport, or at an event location parking lot.

The expected range for each EV depends upon battery capacity as well as travel conditions, e.g., road topology, traffic conditions and weather conditions. Extending that range requires a recharge capability at the end of the charge. Typical charging stations are classed in 3 classes according to distance from hourly charging with an hour charge in: level 1 stations providing an 8 mile range; level 2 stations providing a 28 mile range; and level 3 stations providing a 50 mile range. Increased EV use and range requires geographically distributed, recharge capacity.

A typical business district, such as a city, is dotted with conveniently located parking lots for parking hydrocarbon vehicles. These existing parking lots have more or less fixed operating costs that may include, for example, employee wages, taxes and mundane upkeep/maintenance costs. Unfortunately, current EV infrastructure has few, sparsely located charging stations that may or may not be located in commercial parking spaces.

Typically, available charging stations locations are not planned, but located haphazardly, on an ad hoc basis. Dispersed EV chargers across a wide area, even in a densely populated city, makes finding an open space with a charger with sufficient capacity a necessity. See, e.g., blinknetwork.com, chargepoint.net, carstations.com, and plugshare.com. Existing public locations may not be suited for EV traffic charging needs, where a recharge may typically take several hours, taking anywhere from 2-8 hours to fully recharge. So, finding the right type of charger can be equally as important as finding the space. Consequently, current EV infrastructure is ill equipped for, and instead, an impediment to, widespread EV adoption.

As EVs become ubiquitous, charging equipped parking lots must become ubiquitous as well. Equipping such an existing lot with charge stations for charging EVs incurs an up-front equipment and installation cost that must be recouped. Moreover, charging stations, especially level 2 and 3 stations, can be a significant additional expense for an existing parking lot owner that also must be recouped. Moreover, charging equipped lots also carry charging costs, expenses that are based on utilization and resource expenses. Typically, these charging costs are time dependent, and set by someone other than the lot owner, e.g., the local electric company. To stay in business, at the very least the charging equipped lot owner must cover all expenses, including these real-time varying expenses, before making a profit. Thus, because lot operating costs depend on both additional fixed and variable expenses, determining a parking and charging price can be a daunting task, and may very well be an impediment to equipping lots with charging stations.

Thus, there is a need for managing EV charging stations and lots equipped with EV charging stations to meet demand and maximize profits. Commercial EV charging stations need management of large-scale charging of EVs in real-time subject to spatial and temporal considerations, price of electricity, locations and number of chargers, capacity of chargers, number of requests, locations of requests, arrival and departure times and demand per EV. Additionally, there is a need for estimating the price of long-term charging permits.

### SUMMARY OF THE INVENTION

A feature of the invention is an EV infrastructure management system for matching EVs with available EV charging stations;

Another feature of the invention is EV infrastructure management system for identifying available EV charging stations with capacity sufficient to satisfy demand based locations for EV charging stations;

Yet another feature of the invention is determining optimal locations for EV charging stations for satisfying demand that is complete charging before the car owner's predetermined desired departure time, while pricing charging at an optimal price for the station owner.

The present invention relates to a system, method and program product for managing charging station usage. After receiving a request for charging capacity in electric vehicle (EV) charging spaces, e.g., located in commercial parking lots, if it can be fulfilled the request is accepted. Each accepted request is matched with available EV charging spaces. A scheduling unit schedules charging for each request to a matched EV charging space when a charging price is predetermined. Otherwise, if a charging price is not previously determined, a pricing unit sets a permit price and schedules charging for the match.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 depicts a cloud computing node according to an embodiment of the present invention;

FIG. 2 depicts a cloud computing environment according to an embodiment of the present invention;

FIG. 3 depicts abstraction model layers according to an embodiment of the present invention;

FIG. 4 shows an example of a preferred electric vehicle (EV) charging system for managing EV occupancy across commercial/public EV parking lots in real-time, according to a preferred embodiment of the present invention;

FIG. 5 shows an example of managing EV charging across commercial parking lots dispersed throughout a geographical area.

### DESCRIPTION OF PREFERRED EMBODIMENTS

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is further understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed and as further indicated hereinbelow.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

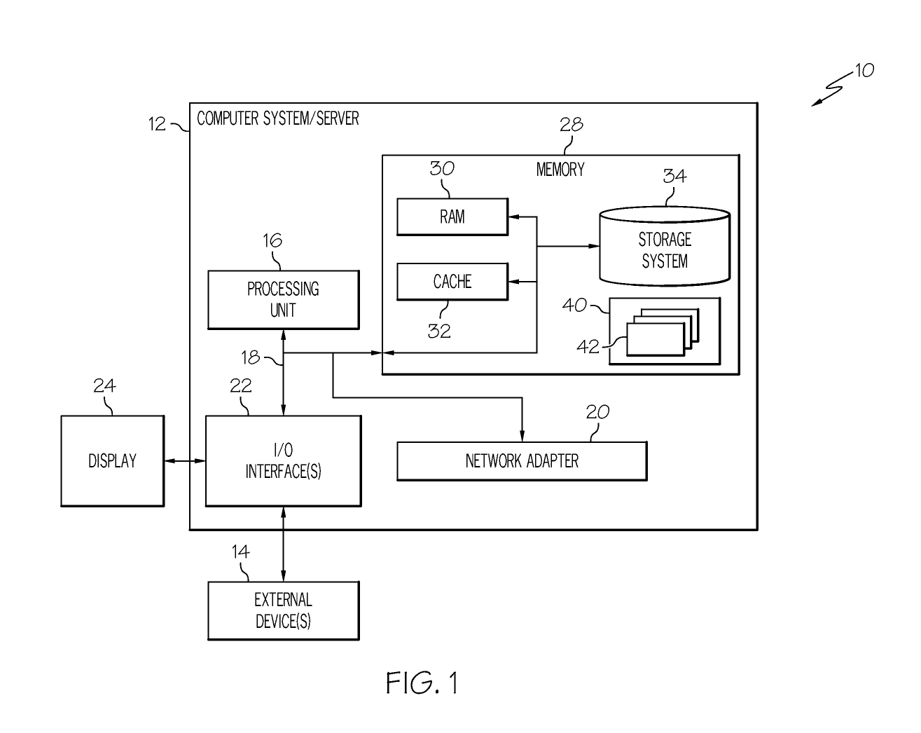

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

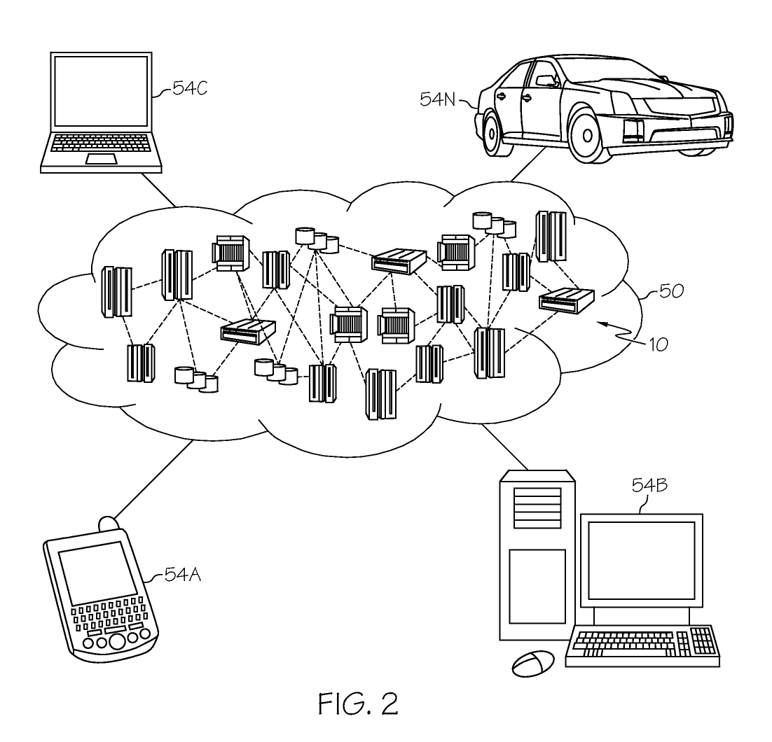

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

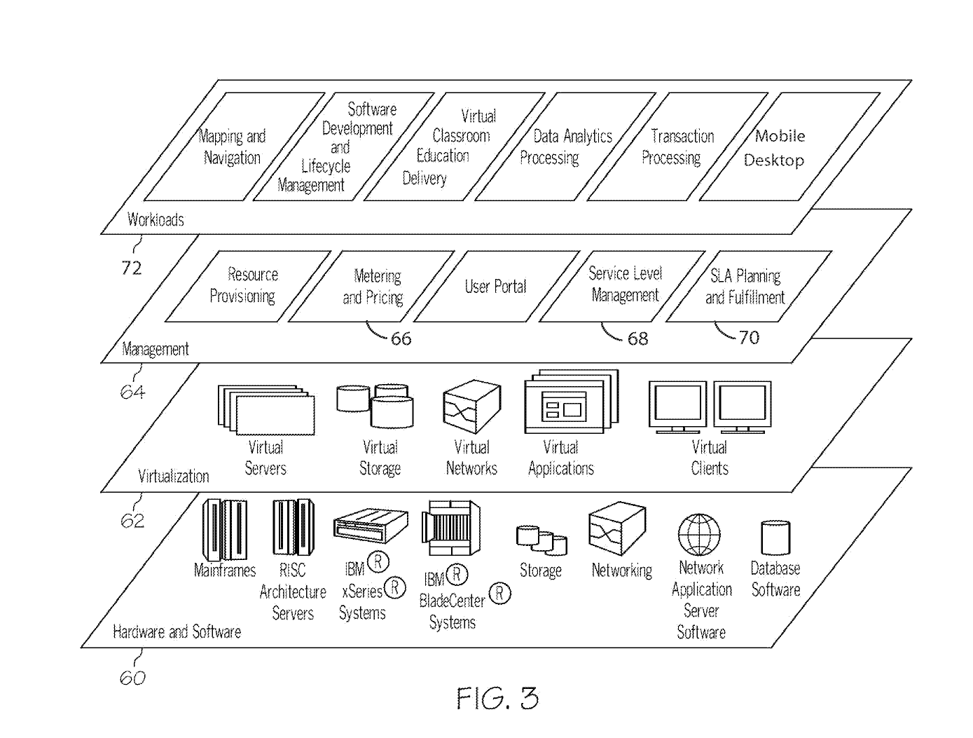

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2®, database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Preferred, context aware resource provisioning provides dynamic procurement of computing resources and other resources that are utilized to perform tasks within the cloud computing environment. Metering and Pricing 66 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Preferred, context aware service level management 68 provides cloud computing resource allocation and management such that required service levels are met. Preferred, context-aware Service Level Agreement (SLA) planning and fulfillment 70 provide pre-arrangement for, and procurement of, cloud computing resources for which a future requirement is anticipated in accordance with an SLA.

Workloads layer 72 provides examples of functionality for which the cloud computing environment may be utilized. Examples of workloads and functions which may be provided from this layer include: mapping and navigation; software development and lifecycle management; virtual classroom education delivery; data analytics processing; transaction processing; and Mobile Desktops.

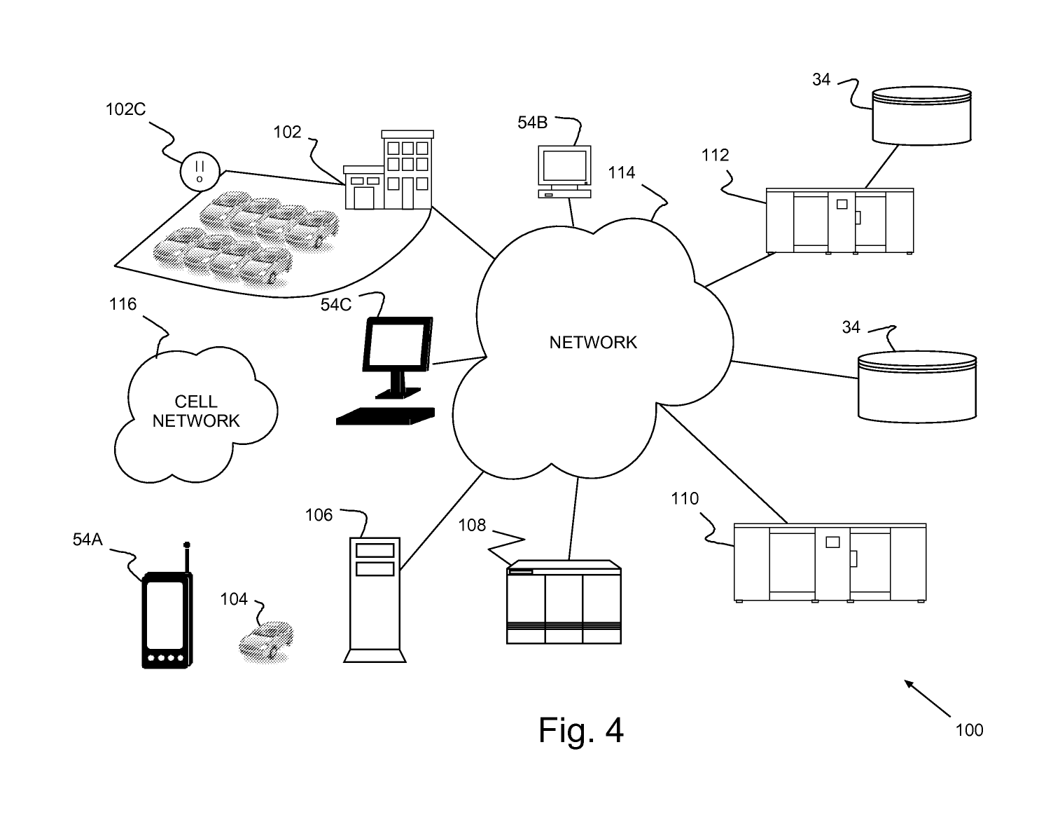

FIG. 4 shows an example of a preferred electric vehicle (EV) charging system 100 for managing EV occupancy across commercial/public EV parking lots 102 in real-time, according to a preferred embodiment of the present invention. The preferred EV charging system 100 manages EV occupancy for the complete set (M) of chargers 102C across all parking lots 102. EV 104 owners request long-term reservations for charging-capable parking spaces in managed lots 102. Each request specifies an arrival and departure time. The preferred EV charging system 100 locates available charger spaces and assists the lot owner(s) in selecting and scheduling an appropriate charger 102C to satisfy each request, while maximizing lot profit.

Preferably, the EV charging system 100 is a cloud based system, such as described with reference to FIGS. 1-3, determining pricing for long-term EV charging permits. In this example, the preferred charging system 100 includes a request handler 106, an assignment unit 108, a scheduler 110 and a pricing unit 112 networked 114 together and with one or more local EV charger equipped parking lots 102. Further, the request handler 106, assignment unit 108, scheduler 110 and pricing unit 112, located on separate computers in this example, may include locally attached or network attached storage 34. Lot 102 owners register with the system 100 over network 114, to accept charging reservations and schedule charging at a price determined to optimize lot/charger profits. Potential lot customers, e.g., EV 104, communicate with the preferred system 100, e.g., over a typical mobile communications network 116, using a typical land-based device 54B, 54C or mobile communications device 54A, such as, a cell phone, a smart phone or a land line from home.

Preferably, the request handler 106 receives EV charging requests from potential lot customers designating, for example, typical or expected arrival and departure times, and parking lot preferences. The assignment unit 108 assigns each request based on requested preferences. If necessary, e.g., during peak parking/charging times, and if charging space prices are already set, the scheduler 110 tentatively schedules each request based on requested preferences, and priced accordingly. If the requests indicates an upper price limit, the scheduler 110 identifies locations within that price limit and schedules the EV. If charging space prices are unknown, i.e., have not previously been agrees upon, the pricing unit 112 tentatively schedules each request based on requested preferences and determines a price for each space that maximizes lot profit.

Lot profit depends on individual charging permit profits as they affect cumulative or aggregate permit profit. Thus, the preferred system 100 balances individual permit profit for each charger space throughout the day against cumulative permit profit. For example, permits may be offered at a lower price for a partially or sparsely occupied lot or during off-peak hours; while a full lot may charge a much higher permit price during peak hours. Thus, permit price may be determined with each space charge/expense characterized by, for example, the day segmented into a set of time slots (T); EV arrival and departure times, i.e., the set of arrival-departure-demand tuples (K); arrival time slot (rₖ) of an EV belonging to kεK; departure time slot (dₖ) of an EV belonging to kεK; EV occupancy rate, the number of EVs (Nₖ) belonging to kεK; and charge demand (Dₖ) in kilowatt hours (kWh) of an EV belonging to kεK. EV occupancy rate, essentially, is the number of simultaneously charging EVs, and varies with arrivals and departures. The Charge demand may be considered as lot/system-wide power consumption and depends on the number of charging vehicles.

For each permit lot profit is the difference between the permit price and corresponding lot overhead and associated operating costs. Unlike existing hydrocarbon vehicle parking lots, projected EV lot 102 operating costs are somewhat more complex. In addition to normal, more or less fixed, pro-rata overhead and operating costs, EV lot 102 operating costs also carry charger costs and charging costs. Charger costs are relatively constant and may include equipment and utilization costs such as, for example, maintenance and repair costs and equipment depreciation. Charging costs, typically, are time dependent and varying, and are based on charging capacity (Rₘ) in kWh/slot of charger mεM; and electricity rates or prices (pₜ) of electricity in kWh/slot.

Preferably, the EV charging system 100 tracks time-varying electricity prices across multiple utility providers. The EV charging system 100 also may track, for example, typical commuter daily arrival-departure schedules, estimated electricity demand, available parking lot charging capacity, estimated demand-price elasticity curves, parking based prices, market rates, electric grid use price variations (e.g., peak and off peak prices), and other macroeconomic conditions. From the tracked prices the EV charging system 100 determines a charging schedule and, if not already set, sets long-term permit prices for managed parking lots 102.

The system 100 sets permit prices to allocate EV charging resources and how to price (pₖ) charging in kWh/slot for an EV belonging to kεK, to maximize profits for managed parking lots 102. Parking and charging permit prices guide consumers (i.e., the requesting EV user') decision and determine lot revenue. Setting prices are too high, encourages potential customers to charge vehicles elsewhere, e.g., at home or at competing lots. With prices set too low, the lot operates at a loss. Thus, the selected price provides an effective mechanism for allocating scarce charging resources, e.g., a limited number of suitably equipped EV parking spaces. As the number of EVs increases, the number of charging equipped spaces in parking lots will also increase. The preferred system 100 adapts pricing to select appropriate permit prices based on the arrival-departure constraints of the larger commuter volume and approximated increase in demand.

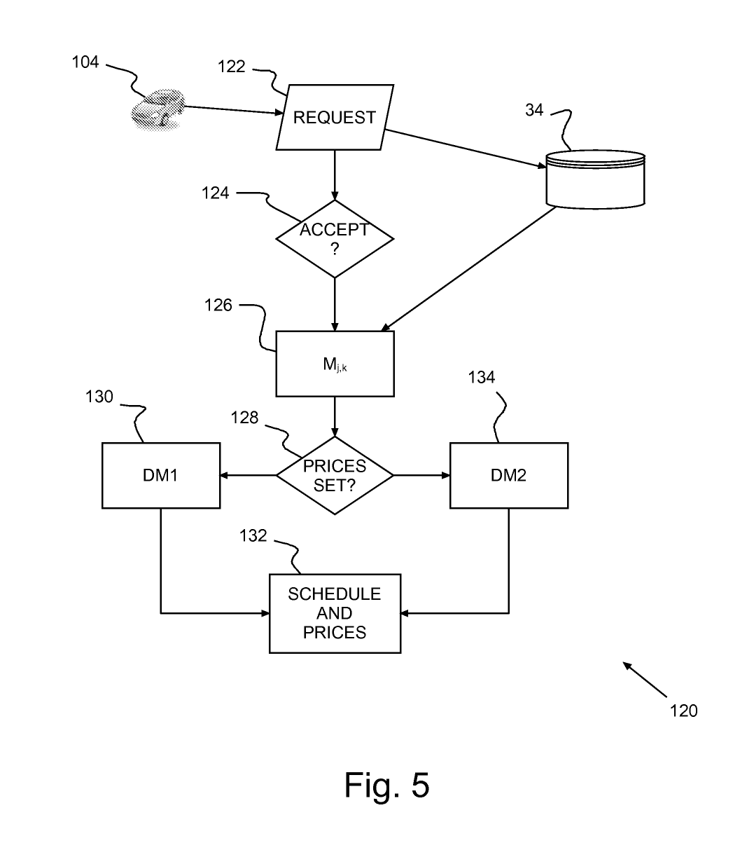

FIG. 5 shows an example of managing 120 EV charging across commercial parking lots 102 dispersed throughout a geographical area, e.g., managed by the system 100 of FIG. 4. An EV 104 user sends a charging request 122 to the preferred request handler 106. If the request can be fulfilled, the request handler 106 tentatively accepts 124 the request for a parking location. The assignment unit 108 uses an assignment optimization or cost model to identify 126 a set (M_{j,k}) of preferred parking lots 102 for EV j from kεK. If charging permit prices are already set 128 for that set of lots, the scheduler 110 optimizes 130 a scheduling model (DM1) that generates an optimum charging schedule 132 for all chargers (X_{j,k,m,t}) in lots (M_{j,k}) at minimal expense to the parking lot 102. During optimization in time slot t, each charger m is empty, unless a demand request j in kεK is assigned to that charger, i.e., X_{j,k,m,t}ε{1,0}. Otherwise, if prices are not previously set 128 for the set of lots M_{j,k}, the pricing unit 112 optimizes 134 a pricing model (DM2) that determines an optimal price and charging schedule 132 for satisfying each request (Y_{j,k}). Thus, a demand request j in kεK is unsatisfied, until it is satisfied, i.e., Y_{j,k}ε{1,0}.

Typical requests 122 may include a travel itinerary, for example, expected arrival and departure times, parking lot preferences and charging electricity demand/capacity requirements, e.g., charger class. The EV owner is pre-registered with the lot manager/owner and have previously negotiated a charging price. Based on the feasibility of fulfilling the new request, the request handler 106 either accepts or rejects the request and stores request and requestor information, e.g., in a customer preference database in storage 34. The customer preference database may be stored locally or remotely.

The customer preference database typically includes arrival time, departure, charging demand and parking lot location preferences for commuters. Further, the customer preference database also may include, for example, charging permit price history, usage pattern history, use locations and corresponding prevailing electricity price history. Commuter lot preferences may be based on, for example, daily parking habits from lot sensors, e.g., on-board diagnostic sensors, and/or commuter requests. In addition, the request handler 106 also may store electricity price information including any time-of-day price variations.

When a new request arrives, the request handler 106 checks the feasibility of fulfilling the new request at any requested parking lot(s), if specified, and the effects on the current schedule of fulfilling that request for the requested lot or at optional surrounding locations. Based on the feasibility results, the request handler 106 provides the lot manager/owner, e.g., over network 114, with an opportunity to accept 124 or reject the request, typically based on the impact to the lot profit margin. If accepted, the assignment unit 108 assigns the request to best suited charging location.

The assignment unit 108 identifies 126 the set of feasible parking locations for each commuter request 122. The assignment unit 108 assigns each vehicle to each commuter's best possible parking lot(s) in accordance with availability and respective location preferences, based on commuter arrival, departure and parking space preferences. Further, the assignment unit 108 leverages available requesting customer information to suggest potentially cheaper, close-to-home or close-to-destination alternative charging points, e.g., close to, or in, the requested ZIP code. Because electricity price may vary by time of day, e.g., have a lower off-peak rate than on-peak, the exact charging times for each vehicle directly affects lot operating costs, and may affect space assignments. So, the assignment unit 108 initially assigns 126 requests to best matched parking lots irrespective of permit price. When the charging price has previously been determined or is otherwise known, the scheduler 110 simply determines the optimal charging schedule 132 that minimizes lot operations cost.

The scheduler 110 applies an optimization solver, such as for example, the IBM ILOG CPLEX Optimizer, to DM1 to determine 130 an optimum charging schedule 132 from the set of preferred parking lots 102, while minimizing lot owner charging costs, i.e., the cost of electricity for charging vehicles (pᵣRₘX_{j,k,m,t}). The schedule 132 identifies any locations that satisfy EV charging requirements for the charging price offered to users in preferred parking lots. Boundary conditions restrain DM1 such that initially, all requests are treated as unsatisfied, i.e., X_{j,k,m,o}=0 ∀jεJₖ, kεK, mεM; and at the end of the scheduling period, all requests are treated as completed, i.e., X_{j,k,m,T+1}=0∀jεJₖ, kεK, mεM. Minimizing lot charging costs includes minimizing connect/disconnect changeovers costs c, costs associated with connecting each EV to a charger or disconnecting it from the charger, i.e., |X_{j,k,m,t}−X_{j,k,m,t-1|.}

Thus, DM1 has the form

$$DM 1 \text{:} min {\sum }_{j , k , m , t}^{ } {p}_{t} {R}_{m} {X}_{j , k , m , t} + {\sum }_{j , k , m , t} c \vert {X}_{j , k , m , t} - {X}_{j , k , m , t - 1} \vert ,$$

and is constrained to ensure: that no vehicle charges before it arrives,

$${\sum }_{t < {r}_{k} , m} {X}_{j , k , m , t} = 0 ∀ j ∈ {J}_{k} , k ∈ K ;$$

that no vehicle charges after its departure Σ_{t>d}_{ₖ}_{,m}X_{j,k,m,t}=0∀jεJₖ,kεK;

$${\sum }_{t > {d}_{k} , m} {X}_{j , k , m , t} = 0 ∀ j ∈ {J}_{k} , k ∈ K ;$$

that at most a single EV can charge at a given charger within a given time slot,

$${\sum }_{j , k} {X}_{j , k , m , t} \leq 1 ∀ m ∈ M , t ∈ T ;$$

that if a vehicle request for charging is accepted, then during a given time slot, that EV can charge on at most one charger,

$${\sum }_{m} {X}_{j , k , m , t} \leq 1 ∀ j ∈ {J}_{k} , k ∈ K , t ∈ T ;$$

that during an EV's stay in the parking lot the lot satisfies demand for that EV,

$${\sum }_{m , t} {R}_{m} {X}_{j , k , m , t} \geq {D}_{k} ∀ j ∈ {J}_{k} , k ∈ K ;$$

and, that no EV is assigned to a parking lot outside of the commuter's set of preferred locations,

$${\sum }_{m ∉ {M}_{j , k}} {X}_{j , k , m , t} = 0 ∀ j ∈ {J}_{k} , k ∈ K , t ∈ T .$$

Thus constrained, the preferred scheduler 110 minimizes objective function, DM1 to identify an optimal charging schedule 132 that minimizes parking lot operations costs based on the cost of electricity, and the offers a charging price to consumers that maximizes profit.

If the prices are unknown, the pricing unit 112 determines whether to accept or reject a charging request based on any specified upper limit, and simultaneously determines the charging price for scheduling requests. The system 100 maintains a system-wide schedule based both on commuter needs and on operating requirements. The pricing unit 112 may also apply an optimization solver, such as for example, the IBM ILOG CPLEX Optimizer, to optimize 134 DM2 simultaneously for pricing, scheduling and assignment, and to determine an optimal price of long-term permits in local parking lots 102. To determine an optimal price of long-term permits, in addition to minimizing lot owner charging expenses and associated connect/disconnect changeovers costs, the pricing unit 112 minimizes overall lot owner charging expenses pₖDₖNₖ.

Again, typical commuter inputs include arrival times, departure times, expected power demand and parking location preferences. Likewise, typical operating requirements include electricity price, resource costs and charging capacity availability. Maximizing DM2 the pricing unit 112 identifies an optimal, system-wide schedule 132 that maximizes owner-operator profit based on permit prices by minimizing lot operating costs. Thus, DM2 has the form

$$DM 2 \text{:} max {\sum }_{k}^{ } {p}_{k} {D}_{k} {N}_{k} {\sum }_{j , k , m , t}^{ } {p}_{t} {R}_{m} {X}_{j , k , m , t} - {\sum }_{j , k , m , t} c \vert {X}_{j , k , m , t} - {X}_{j , k , m , t - 1} \vert .$$

and is constrained to ensure: that the number of vehicles in each price bucket k conforms with its price versus demand curve indicated by

Nₖ=[aₖ−bₖpₖ]∀kεK;

that the number of accepted requests for each lot for each bucket k is the same as the number of EVs, conforming to the price-demand curve in DM2,

$${\sum }_{j} {Y}_{j , k} = {N}_{k} ∀ k ∈ K ;$$

that no vehicle charges before it arrives,

$${\sum }_{t < {r}_{k} , m} {X}_{j , k , m , t} = 0 ∀ j ∈ {J}_{k} , k ∈ K ;$$

that no vehicle charges after its departure Σ_{d}_{ₖ}_{,m}X_{j,k,m,t}=0 ∀jεJₖ, kεK;

$${\sum }_{t > {d}_{k} , m} {X}_{j , k , m , t} = 0 ∀ j ∈ {J}_{k} , k ∈ K ;$$

that at most a single EV can charge at a given charger within a given time slot,

$${\sum }_{j , k} {X}_{j , k , m , t} \leq 1 ∀ m ∈ M , t ∈ T ;$$

that if a vehicle request for charging is accepted, then during a given time slot, that EV can charge on at most one charger,

$${\sum }_{m} {X}_{j , k , m , t} \leq 1 ∀ j ∈ {J}_{k} , k ∈ K , t ∈ T ;$$

that during an EV's stay in the parking lot, the lot satisfies demand for that EV,

$${\sum }_{m , t} {R}_{m} {X}_{j , k , m , t} \geq {D}_{k} ∀ j ∈ {J}_{k} , k ∈ K ;$$

and, that no EV is assigned to a parking lot outside of the commuter's set of preferred locations,

$${\sum }_{m ∉ {M}_{j , k}} {X}_{j , k , m , t} = 0 ∀ j ∈ {J}_{k} , k ∈ K , t ∈ T ;$$

The pricing unit 112 combines the price of charging with the base parking price for each space to generate a monthly parking permit price. Thus constrained, the pricing unit 112 combines the pricing and scheduling information in a charging schedule 132 that minimizes lot electricity costs, sets the charging price for permits, and while maximizing lot owner profit.

Advantageously, the preferred system better utilizes limited parking lot resources, optimally assigning EVs to best suited parking lots based on charge demand to maximize customer satisfaction and lot revenue and profit, with minimum charging cost and delays. Further, when charging demand is known and permit prices are previously set, the preferred system quickly determines an optimal charging schedule that minimizes the vehicles charging expenses for the parking lot. When charging demand and/or permit prices are unknown, the preferred system facilitates deciding whether to accept or reject requests, and simultaneously, determines parking permit prices for accepted requests with an optimal charging schedule to maximize lot owner profit. Thus, an owner-operator may accept or reject charging requests to manage system-wide charging demand, temporally and spatially, while maximizing profits and demand met, and minimizing overhead costs and idle chargers.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system for managing charging station usage, said system comprising:
a plurality of electric vehicle (EV) charging spaces distributed in an area, each EV charging space being equipped with charger for charging an EV;
an assignment unit matching charging requests in said area with available said EV charging spaces;
a scheduler scheduling an EV for each request to a matched EV charging space; and
a pricing unit setting permit prices for said plurality of EV charging spaces.

2. A system as in claim 1, wherein ones of said plurality of EV charging spaces (X) are located in a plurality of parking lots (M), each parking lot including one or more of said plurality of EV charging spaces.

3. A system as in claim 2, wherein said assignment unit, said scheduler and said pricing unit are provisioned in one or more cloud computers, said system further comprising:
a customer preference database includes charging permit price history, usage pattern history, use locations and corresponding prevailing electricity price history; and
a request handler receiving requests for time at EV charging spaces, said request handler checking the feasibility of fulfilling each new request at any requested parking lot, said request handler storing new request information in said customer preference database.

4. A system as in claim 2, further comprising a network, said assignment unit assigning EVs to at least one of said plurality of EV charging spaces based on requested preferences in a respective new request.

5. A system as in claim 2, wherein for the set of chargers M across all lots; the set of daily time slots T; the EVs have K charge demand time tuples, and there are Nₖ EVs belonging to kεK; each EV has an arrival time slot rₖ and a departure time slot dₖ for kεK; Demand is Dₖ in kWh for EV kεK; the electricity price is pₜ in kWh/slot; charging capacity is Rₘ in kWh/slot of charger mεM; and, wherein the assignment unit provides a set of preferred chargers M_{j,k} for vehicle j from kεK; a request X_{j,k,m,t} is either scheduled or not demand request j in kεK is assigned to that charger, X_{j,k,m,t}ε{1,0}; each request Y_{j,k} is satisfied or unsatisfied, Y_{j,k}ε{1,0}; before the first time slot all requests are unsatisfied, X_{j,k,m,o}=0∀jεJₖ, kεK, mεM; and after the last time slot all requests are treated as completed, X_{j,k,m,T+1}=0 ∀jεJₖ, kεK, mεM.

6. A system as in claim 5, wherein said scheduler schedules EVs for charging time in at least one of said plurality of EV charging spaces based on requested preferences in a respective matched request and a predetermined charging rate, EVs being scheduled to minimize lot owner charging expenses for the EV pᵣRₘX_{j,k,m,t}, and to minimize associated connect/disconnect changeovers costs c.

7. A system as in claim 6, wherein said scheduler schedules EVs with an optimization model (DM1) having the form
$$DM 1 \text{:} min {\sum }_{j , k , m , t} {p}_{t} {R}_{m} {X}_{j , k , m , t} + {\sum }_{j , k , m , t} c \vert {X}_{j , k , m , t} - {X}_{j , k , m , t - 1} \vert ,$$
and is constrained to ensure: that no vehicle charges before it arrives,
$${\sum }_{t < {r}_{k} , m} {X}_{j , k , m , t} = 0 ∀ j ∈ {J}_{k} , k ∈ K ;$$
that no vehicle charges after its departure Σ_{t>d}_{ₖ}_{,m}X_{j,k,m,t}=0 ∀jεJₖ,kεK;
$${\sum }_{t > {d}_{k} , m} {X}_{j , k , m , t} = 0 ∀ j ∈ {J}_{k} , k ∈ K ;$$
that at most a single EV can charge at a given charger within a given time slot,
$${\sum }_{j , k} {X}_{j , k , m , t} \leq 1 ∀ m ∈ M , t ∈ T ;$$
that if a vehicle request for charging is accepted, then during a given time slot, that EV can charge on at most one charger,
$${\sum }_{m} {X}_{j , k , m , t} \leq 1 ∀ j ∈ {J}_{k} , k ∈ K , t ∈ T ;$$
that during an EV's stay in the parking lot the lot satisfies demand for that EV,
$${\sum }_{m , t} {R}_{m} {X}_{j , k , m , t} \geq {D}_{k} ∀ j ∈ {J}_{k} , k ∈ K ;$$
and, that no EV is assigned to a parking lot outside of the commuter's set of preferred locations,
$${\sum }_{m ∉ {M}_{j , k}} {X}_{j , k , m , t} = 0 ∀ j ∈ {J}_{k} , k ∈ K , t ∈ T ;$$
each demand request being charged according to said predetermined charging rate.

8. A system as in claim 5, wherein said pricing unit prices charging time for scheduled EVs in at least one of said plurality of EV charging spaces based on requested preferences in a respective matched request, EVs being scheduled to minimize overall lot owner charging expenses pₖDₖNₖ, minimize lot owner charging expenses for the EV pᵣRₘX_{j,k,m,t}, and minimize associated connect/disconnect changeovers costs c.

9. A system as in claim 8, wherein said pricing unit schedules EVs and prices charger time with an optimization model (DM2) having the form
$$DM 2 \text{:} max {\sum }_{k} {p}_{k} {D}_{k} {N}_{k} {\sum }_{j , k , m , t} {p}_{t} {R}_{m} {X}_{j , k , m , t} - {\sum }_{j , k , m , t} c \vert {X}_{j , k , m , t} - {X}_{j , k , m , t - 1} \vert .$$
and is constrained to ensure: that the number of vehicles in each price bucket k conforms with its price versus demand curve indicated by
Nₖ=[aₖ−bₖpₖ]∀kεK;
that the number of accepted requests for each lot for each bucket k is the same as the number of EVs, conforming to the price-demand curve in DM1,
$${\sum }_{j} {Y}_{j , k} = {N}_{k} ∀ k ∈ K ;$$
that no vehicle charges before it arrives,
$${\sum }_{t < {r}_{k} , m} {X}_{j , k , m , t} = 0 ∀ j ∈ {J}_{k} , k ∈ K ;$$
that no vehicle charges after its departure Σ_{t>d}_{ₖ}_{,m}X_{j,k,m,t}=0 ∀jεJₖ, kεK;
$${\sum }_{t > {d}_{k} , m} {X}_{j , k , m , t} = 0 ∀ j ∈ {J}_{k} , k ∈ K ;$$
that at most a single EV can charge at a given charger within a given time slot,
$${\sum }_{j , k} {X}_{j , k , m , t} \leq 1 ∀ m ∈ M , t ∈ T ;$$
that if a vehicle request for charging is accepted, then during a given time slot, that EV can charge on at most one charger,
$${\sum }_{m} {X}_{j , k , m , t} \leq 1 ∀ j ∈ {J}_{k} , k ∈ K , t ∈ T ;$$
that during an EV's stay in the parking lot the lot satisfies demand for that EV,
$${\sum }_{m , t} {R}_{m} {X}_{j , k , m , t} \geq {D}_{k} ∀ j ∈ {J}_{k} , k ∈ K ;$$
and, that no EV is assigned to a parking lot outside of the commuter's set of preferred locations,
$${\sum }_{m ∉ {M}_{j , k}} {X}_{j , k , m , t} = 0 ∀ j ∈ {J}_{k} , k ∈ K , t ∈ T .$$

10. A system as in claim 9, wherein said, and said scheduler schedules EVs for charging time in at least one of said plurality of EV charging spaces based on requested preferences in a respective matched request and a predetermined charging rate, said predetermined charging rate being previously determined by said pricing unit.

11. A method of managing charging stations at a plurality of distributed locations, said method comprising:
receiving a charging request for charging time in one of a plurality of electric vehicle (EV) charging spaces distributed in an area, each EV charging space being equipped with charger for charging an EV, said request indicating one or more preferred charging locations;
matching said charging request with available said EV charging spaces in said area;
selectively scheduling said EV to a matched EV charging space; and
selectively setting a price for said matched EV charging space.

12. A method as in claim 11, wherein receiving said charging request comprises:
determining whether said received request can be fulfilled by available ones of said plurality of EV charging spaces; and
selectively accepting said charging request responsive to said determination.

13. A method as in claim 11, wherein said charging request indicates charging location preferences for the set of chargers M across all said charging locations, arrival and departure times within the set of daily time slots T, and parking space preferences, and matching said charging request comprises identifying preferred locations with capabilities matching indicated charging location preferences during the requested charging time.

14. A method as in claim 13, wherein matching said charging request further comprises identifying alternate locations with capabilities matching indicated charging location preferences during the requested charging time.

15. A method as in claim 14, wherein said EV is one of a plurality of EVs with accepted charging requests having K charge demand time tuples, and there are Nₖ EVs belonging to kεK; each EV has an arrival time slot rₖ and a departure time slot dₖ for kεK; and matching provides a set of preferred chargers M_{j,k} for vehicle j from kεK.

16. A method as in claim 15, wherein
Demand is Dₖ in kWh for EV kεK; the electricity price is pₜ in kWh/slot;
charging capacity is Rₘ in kWh/slot of charger mεM;
a request X_{j,k,m,t} is either scheduled or not demand request j in kεK is assigned to that charger, X_{j,k,m,t}ε{1,0};
each request Y_{j,k} is satisfied or unsatisfied, Y_{j,k}ε{1,0};
before the first time slot all requests are unsatisfied, X_{j,k,m,o}=0∀jεJₖ, kεK, mεM; and
after the last time slot all requests are treated as completed, X_{j,k,m,T+1}=0 ∀jεJₖ,kεK, mεM.

17. A method as in claim 16, wherein selectively scheduling optimizes an optimization model (DM1) scheduling EVs for charging time in at least one of said plurality of EV charging spaces based on requested preferences in a respective matched request whenever a charging rate is preselected, EVs being scheduled to minimize lot owner charging expenses for the EV pᵣRₘX_{j,k,m,t}, and to minimize associated connect/disconnect changeovers costs c, DM1 has the form
$$DM 1 \text{:} min {\sum }_{j , k , m , t} {p}_{t} {R}_{m} {X}_{j , k , m , t} + {\sum }_{j , k , m , t} c \vert {X}_{j , k , m , t} - {X}_{j , k , m , t - 1} \vert ,$$
and DM1 is constrained to ensure: that no vehicle charges before it arrives,
$${\sum }_{t < {r}_{k} , m} {X}_{j , k , m , t} = 0 ∀ j ∈ {J}_{k} , k ∈ K ;$$
that no vehicle charges after its departure Σ_{t>d}_{ₖ}_{,m}X_{j,k,m,t}=0 ∀jεJₖ, kεK;
$${\sum }_{t > {d}_{k} , m} {X}_{j , k , m , t} = 0 ∀ j ∈ {J}_{k} , k ∈ K ;$$
that at most a single EV can charge at a given charger within a given time slot,
$${\sum }_{j , k} {X}_{j , k , m , t} \leq 1 ∀ m ∈ M , t ∈ T ;$$
that if a vehicle request for charging is accepted, then during a given time slot, that EV can charge on at most one charger,
$${\sum }_{m} {X}_{j , k , m , t} \leq 1 ∀ j ∈ {J}_{k} , k ∈ K , t ∈ T ;$$
that during an EV's stay in the parking lot the lot satisfies demand for that EV,
$${\sum }_{m , t} {R}_{m} {X}_{j , k , m , t} \geq {D}_{k} ∀ j ∈ {J}_{k} , k ∈ K ;$$
and, that no EV is assigned to a parking lot outside of the commuter's set of preferred locations,
$${\sum }_{m ∉ {M}_{j , k}} {X}_{j , k , m , t} = 0 ∀ j ∈ {J}_{k} , k ∈ K , t ∈ T ,$$
each demand request being charged according to said predetermined charging rate.

18. A method as in claim 16, wherein whenever a charging rate is not previously set selectively pricing optimizes an optimization model (DM2) setting prices for scheduled EVs in at least one of said plurality of EV charging spaces based on requested preferences in a respective matched request, EVs being scheduled to minimize overall lot owner charging expenses pₖDₖNₖ, minimize lot owner charging expenses for the EV pᵣRₘX_{j,k,m,t}, and minimize associated connect/disconnect changeovers costs c, DM2 has the form
$$DM 2 \text{:} max {\sum }_{k} {p}_{k} {D}_{k} {N}_{k} {\sum }_{j , k , m , t} {p}_{t} {R}_{m} {X}_{j , k , m , t} - {\sum }_{j , k , m , t} c \vert {X}_{j , k , m , t} - {X}_{j , k , m , t - 1} \vert .$$
and is constrained to ensure: that the number of vehicles in each price bucket k conforms with its price versus demand curve indicated by
Nₖ=[aₖ−bₖpₖ]∀kεK;
that the number of accepted requests for each lot for each bucket k is the same as the number of EVs, conforming to the price-demand curve in DM1,
$${\sum }_{j} {Y}_{j , k} = {N}_{k} ∀ k ∈ K ;$$
that no vehicle charges before it arrives,
$${\sum }_{t < {r}_{k} , m} {X}_{j , k , m , t} = 0 ∀ j ∈ {J}_{k} , k ∈ K ;$$
that no vehicle charges after its departure Σ_{t>d}_{ₖ}_{,m}X_{j,k,m,t}=0 ∀jεJₖ, kεK;
$${\sum }_{t > {d}_{k} , m} {X}_{j , k , m , t} = 0 ∀ j ∈ {J}_{k} , k ∈ K ;$$
that at most a single EV can charge at a given charger within a given time slot,
$${\sum }_{j , k} {X}_{j , k , m , t} \leq 1 ∀ m ∈ M , t ∈ T ;$$
that if a vehicle request for charging is accepted, then during a given time slot, that EV can charge on at most one charger,
$${\sum }_{m} {X}_{j , k , m , t} \leq 1 ∀ j ∈ {J}_{k} , k ∈ K , t ∈ T ;$$
that during an EV's stay in the parking lot the lot satisfies demand for that EV,
$${\sum }_{m , t} {R}_{m} {X}_{j , k , m , t} \geq {D}_{k} ∀ j ∈ {J}_{k } , k ∈ K ;$$
and, that no EV is assigned to a parking lot outside of the commuter's set of preferred locations,
$${\sum }_{m ∉ {M}_{j , k}} {X}_{j , k , m , t} = 0 ∀ j ∈ {J}_{k} , k ∈ K , t ∈ T .$$

19. A method as in claim 18, wherein said selectively scheduling schedules EVs for charging time in at least one of said plurality of EV charging spaces based on requested preferences in a respective matched request and a predetermined charging rate, said predetermined charging rate being previously determined by pricing as determined in claim 18.

20. A computer program product for managing charging station usage, said computer program product comprising a non-transitory computer usable medium having computer readable program code stored thereon, said computer readable program code comprising:
computer readable program code means for receiving request for charging capacity in one of a plurality of electric vehicle (EV) charging spaces (X) distributed in an area, each EV charging space being equipped with charger for charging an EV, ones of said plurality of EV charging spaces being located in a plurality of parking lots (M), each parking lot including one or more of said plurality of EV charging spaces;
computer readable program code means for a customer preference database includes charging permit price history, usage pattern history, use locations and corresponding prevailing electricity price history;
computer readable program code means for matching charging accepted requests with available said EV charging spaces in said area;
computer readable program code means for scheduling charging an EV for each request to a matched EV charging space when a charging price is predetermined; and
computer readable program code means for setting permit prices and scheduling charging for said plurality of EV charging spaces when a charging price is not previously determined.

21. A computer program product for managing charging station usage as in claim 20, wherein said computer readable program code means for receiving requests receiving requests for the set of chargers M across all lots, checks the feasibility of fulfilling each new request at any requested parking lot, and stores new request information in said customer preference database; the set of daily time slots T; the EVs have K charge demand time tuples, and there are Nₖ EVs belonging to kεK; each EV has an arrival time slot rₖ and a departure time slot dₖ for kεK; Demand is Dₖ in kWh for EV kεK; the electricity price is pₜ in kWh/slot; charging capacity is Rₘ in kWh/slot of charger mεM; and, wherein the assignment unit provides a set of preferred chargers M_{j,k} for vehicle j from kεK; a request X_{j,k,m,t} is either scheduled or not demand request j in kεK is assigned to that charger, X_{j,k,m,t}ε{1,0}; each request Y_{j,k} is satisfied or unsatisfied, Y_{j,k}ε{1,0}; before the first time slot all requests are unsatisfied, X_{j,k,m,o}=0∀jεJₖ, kεK, mεM; and after the last time slot all requests are treated as completed, X_{j,k,m,T+1}=0 ∀jεJₖ, kεK, mεM.

22. A computer program product for managing charging station usage as in claim 21, wherein said computer readable program code means for scheduling comprises computer readable program code means for optimizing an optimization model (DM1) scheduling EVs for charging time in at least one of said plurality of EV charging spaces based on requested preferences in a respective matched request whenever a charging rate is preselected, EVs being scheduled to minimize lot owner charging expenses for the EV pᵣRₘX_{j,k,m,t}, and to minimize associated connect/disconnect changeovers costs c, DM1 has the form
$$DM 1 \text{:} min {\sum }_{j , k , m , t} {p}_{t} {R}_{m} {X}_{j , k , m , t} + {\sum }_{j , k , m , t} c \vert {X}_{j , k , m , t} - {X}_{j , k , m , t - 1} \vert ,$$
and DM1 is constrained to ensure: that no vehicle charges before it arrives,
$${\sum }_{t < {r}_{k} , m} {X}_{j , k , m , t} = 0 ∀ j ∈ {J}_{k} , k ∈ K ;$$
that no vehicle charges after its departure Σ_{t>d}_{ₖ}_{,m}X_{j,k,m,t}=0 ∀jεJₖ, kεK;
$${\sum }_{t > {d}_{k} , m} {X}_{j , k , m , t} = 0 ∀ j ∈ {J}_{k} , k ∈ K ;$$
that at most a single EV can charge at a given charger within a given time slot,
$${\sum }_{j , k} {X}_{j , k , m , t} \leq 1 ∀ m ∈ M , t ∈ T ;$$
that if a vehicle request for charging is accepted, then during a given time slot, that EV can charge on at most one charger,
$${\sum }_{m} {X}_{j , k , m , t} \leq 1 ∀ j ∈ {J}_{k} , k ∈ K , t ∈ T ;$$
that during an EV's stay in the parking lot the lot satisfies demand for that EV,
$${\sum }_{m , t} {R}_{m} {X}_{j , k , m , t} \geq {D}_{k} ∀ j ∈ {J}_{k} , k ∈ K ;$$
and, that no EV is assigned to a parking lot outside of the commuter's set of preferred locations,
$${\sum }_{m ∉ {M}_{j , k}} {X}_{j , k , m , t} = 0 ∀ j ∈ {J}_{k} , k ∈ K , t ∈ T ,$$
each demand request being charged according to said predetermined charging rate.

23. A computer program product for managing charging station usage as in claim 21, wherein said computer readable program code means for setting permit prices and scheduling charging comprises computer readable program code means for optimizing an optimization model (DM2) setting prices for scheduled EVs in at least one of said plurality of EV charging spaces based on requested preferences in a respective matched request, EVs being scheduled to minimize overall lot owner charging expenses pₖDₖNₖ, minimize lot owner charging expenses for the EV pᵣRₘX_{j,k,m,t}, and minimize associated connect/disconnect changeovers costs c, DM2 has the form
$$DM 2 \text{:} max {\sum }_{k} {p}_{k} {D}_{k} {N}_{k} {\sum }_{j , k , m , t} {p}_{t} {R}_{m} {X}_{j , k , m , t} - {\sum }_{j , k , m , t} c \vert {X}_{j , k , m , t} - {X}_{j , k , m , t - 1} \vert .$$
and is constrained to ensure: that the number of vehicles in each price bucket k conforms with its price versus demand curve indicated by
Nₖ=[aₖ−bₖpₖ]∀kεK;
that the number of accepted requests for each lot for each bucket k is the same as the number of EVs, conforming to the price-demand curve in DM1,
$${\sum }_{j} {Y}_{j , k} = {N}_{k} ∀ k ∈ K ;$$
that no vehicle charges before it arrives,
$${\sum }_{t < {r}_{k} , m} {X}_{j , k , m , t} = 0 ∀ j ∈ {J}_{k} , k ∈ K ;$$
that no vehicle charges after its departure Σ_{t>d}_{ₖ}_{,m}X_{j,k,m,t}=0 ∀jεJₖ, kεK;
$${\sum }_{t > {d}_{k} , m} {X}_{j , k , m , t} = 0 ∀ j ∈ {J}_{k} , k ∈ K ;$$
that at most a single EV can charge at a given charger within a given time slot,
$${\sum }_{j , k} {X}_{j , k , m , t} \leq 1 ∀ m ∈ M , t ∈ T ;$$
that if a vehicle request for charging is accepted, then during a given time slot, that EV can charge on at most one charger,
$${\sum }_{m} {X}_{j , k , m , t} \leq 1 ∀ j ∈ {J}_{k} , k ∈ K , t ∈ T ;$$
that during an EV's stay in the parking lot the lot satisfies demand for that EV,
$${\sum }_{m , t} {R}_{m} {X}_{j , k , m , t} \geq {D}_{k} ∀ j ∈ {J}_{k} , k ∈ K ;$$
and, that no EV is assigned to a parking lot outside of the commuter's set of preferred locations,
$${\sum }_{m ∉ {M}_{j , k}} {X}_{j , k , m , t} = 0 ∀ j ∈ {J}_{k} , k ∈ K , t ∈ T .$$

24. A computer program product for managing charging station usage, said computer program product comprising a computer usable medium having computer readable program code stored thereon, said computer readable program code causing a plurality of computers executing said code to:
receive a charging request for charging time in one of a plurality of electric vehicle (EV) charging spaces distributed in an area, each EV charging space being equipped with charger for charging an EV, said request indicating one or more preferred charging locations;
match said charging request with available said EV charging spaces in said area;
schedule said EV to a matched EV charging space whenever a price for charging is predetermined; and
set a price for said matched EV charging space and schedule said EV to said matched EV charging space whenever a price for charging is previously set.
